(19) United States
(12) Patent Application Publication
(10) Pub. No.: US 2017/0195236 A1
(43) Pub. Date: Jul. 6, 2017

(54) COMMUNICATION METHOD AND COMMUNICATION DEVICE

(71) Applicant: FUJITSU LIMITED, Kawasaki-shi (JP)

(72) Inventors: Yu Arimatsu, Kawasaki (JP); Chansu Paku, Yokohama (JP)

(73) Assignee: FUJITSU LIMITED, Kawasaki-shi (JP)

(21) Appl. No.: 15/377,987

(22) Filed: Dec. 13, 2016

(30) Foreign Application Priority Data
Jan. 5, 2016 (JP) 2016-000612

(51) Int. Cl. H04L 12/851; H04L 12/751; H04L 12/721; H04L 12/715

(52) U.S. Cl. CPC H04L 47/24; H04L 45/64; H04L 45/02; H04L 45/38

(57) ABSTRACT

A communication method executed by a processor included in a communication device to process a packet based on a processing rule determined by a control device, the communication method includes acquiring, from the control device, a setting message including a combination of an information element of which the control device is notified at a time of inquiring the processing rule and characteristic information indicating a characteristic of a packet serving as a target for which the processing rule is inquired; receiving a packet serving a processing target; generating a request message that is used for requesting the processing rule and that includes a value of the information element, which corresponds to the received packet, when the received packet satisfies the characteristic information included in the setting message; and transmitting the request message to the control device.

### CROSS-REFERENCE TO RELATED APPLICATION

This application is based upon and claims the benefit of priority of the prior Japanese Patent Application No. 2016-000612, filed on Jan. 5, 2016, the entire contents of which are incorporated herein by reference.

### FIELD

The embodiments discussed herein are related to a communication method and a communication device.

### BACKGROUND

In recent years, research and development of systems compatible with software defined networking (SDN) have been advanced. In addition, various SDN controllers, SDN switches, SDN routers, and so forth have been provided. In some cases, an OpenFlow (OF) protocol is used for communication between a controller and a switch or router.

FIG. 1 is a diagram for explaining an example of transfer processing based on an open flow. In a network illustrated in FIG. 1, an OF controller 4 and an OF switch 2 are coupled to each other by using a control line L3. A data line L1 and a data line L2 are further coupled to the OF switch 2. In the OpenFlow, the OF controller 4 determines a processing method for packets in the OF switch 2 within the network. In accordance with a processing rule given notice of by the OF controller 4, the OF switch 2 processes reception packets.

First, the OF controller 4 transmits, to the OF switch 2, a control message for requesting to inquire, of the OF controller 4, a processing method for a packet to which no processing rule stored in the OF switch 2 is applied (arrow A1). Then, in a case of receiving a packet to which no processing rule stored therein is applied, the OF switch 2 stores inquiring, of the OF controller 4 via the control line L3, a processing method for the reception packet. In a stage in which the OF switch 2 initiates an operation, the OF switch 2 only stores information given notice of by the arrow A1. After that, the OF switch 2 further stores, as a processing rule, information acquired as a result of inquiring the processing method for the reception packet of the OF controller 4.

A table T1 is an example of a flow table held by the OF switch 2. The flow table includes an item number, a match condition, and an operation. Entries each include a processing rule of a packet. The OF switch 2 compares information within a header of the reception packet with a match condition within the flow table. In addition, the OF switch 2 performs, on the reception packet, an operation associated with a match condition of the reception packet. Here, the OF switch 2 preferentially applies an entry having a smaller item number. A user packet P1 is transmitted to the OF switch 2 from the data line L1, for example (arrow A2). In a case where a destination address of the packet P1 is 10.0.0.0/8, the packet P1 is matched with a condition of an item number #1. Therefore, upon receiving the packet P1, the OF switch 2 transfers the packet P1 to the data line L2, as illustrated in an arrow A3. On the other hand, in a case where the destination address of the packet P1 does not fit the condition of 10.0.0.0/8, processing for the item number #1 is not applied to the packet P1. Then, the OF switch 2 determines whether to process the packet P1, based on a condition of an item number #2. Since being applied to a packet received by the OF switch 2 from the data line L2, the condition of the item number #2 is not applied to the packet P1. Therefore, in accordance with a condition of an item number #3, the OF switch 2 transmits, to the OF controller 4 from the control line L3, a Packet-In message P2 for inquiring a processing method for the packet P1 of the OF controller 4 (arrow A4).

FIG. 2 is a diagram for explaining an example of a Packet-In message. FIG. 2 illustrates examples of information elements included in the Packet-In message P2 transmitted by processing in the arrow A4 in FIG. 1. The Packet-In message includes a common header, a Packet-In header, a match field, and packet data (Packet raw data). The number of the match fields included in 1 Packet-In message may be 2 or more. The match fields each include an input port at a time when the OF switch 2 receives a reception packet serving as a target of inquiring a processing rule, and header information of the reception packet. As the header information, a destination media access control (MAC) address, a transmission source MAC address, an Ethernet (registered trademark) type, a destination Internet Protocol (IP) address, and so forth may be included. The packet data is at least part of the reception packet serving as a target of inquiring a processing rule. The packet data does not have to be included in the Packet-In message.

By using information within the corresponding one of the match fields included in the Packet-In message P2 received from the OF switch 2, the OF controller 4 determines a method for processing to be performed by the OF switch 2 on the packet serving as a target of the inquiry. At a time of determining the method for the processing in the OF switch 2, the OF controller 4 arbitrarily further uses topology information of the network or the like. By using a FlowMod message, the OF controller 4 notifies the OF switch 2 of a processing rule indicating a content of the determined processing method. Then, the OF switch 2 stores therein information given notice of and processes the reception packet P1 in accordance with the information given notice of.

As a related technology, there is a proposed a system for identifying, by using a transmission source MAC address and a port number of a packet transferred from a terminal, a port number of a node device, to which the terminal coupled to a node device group is coupled. In a case where a combination of a port number and a transmission source MAC address of the reception packet is not included in a search table, the node device notifies a control device of the port number and transmission source MAC address information of the reception packet. As a related art, International Publication Pamphlet No. WO 2012/137646 or the like is disclosed, for example.

In many cases, by using part of information included in a control message received from a switch, a controller determines processing of a packet in a switch serving as an inquiry source. In a case where information not to be used in the controller is transmitted to the controller by the switch, useless data to be discarded in the controller turns out to be transmitted and received between the controller and the switch, and an efficiency is reduced. In view of the above, it is desirable that it is possible to make communication between the controller and the switch or a router more efficient.

### SUMMARY

According to an aspect of the invention, a communication method executed by a processor included in a communication device to process a packet based on a processing rule determined by a control device, the communication method includes acquiring, from the control device, a setting message including a combination of an information element of which the control device is notified at a time of inquiring the processing rule and characteristic information indicating a characteristic of a packet serving as a target for which the processing rule is inquired; receiving a packet serving a processing target; generating a request message that is used for requesting the processing rule and that includes a value of the information element, which corresponds to the received packet, when the received packet satisfies the characteristic information included in the setting message; and transmitting the request message to the control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of transfer processing based on an open flow;

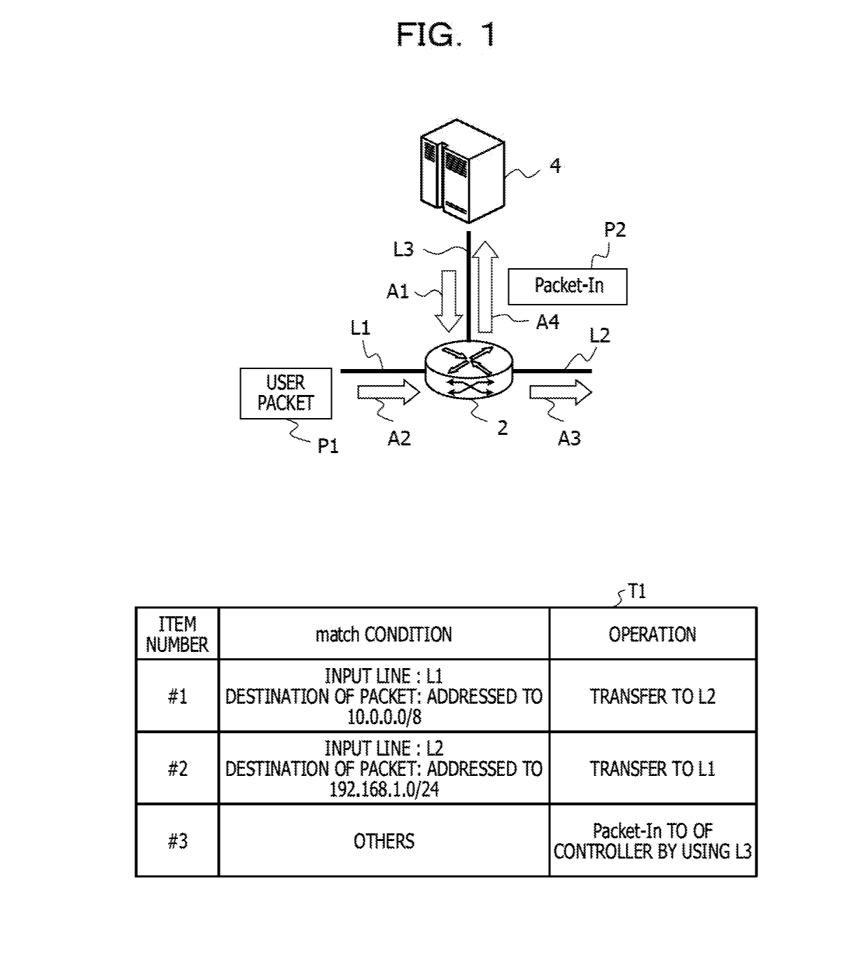

FIG. 2 is a diagram for explaining an example of a Packet-In message;

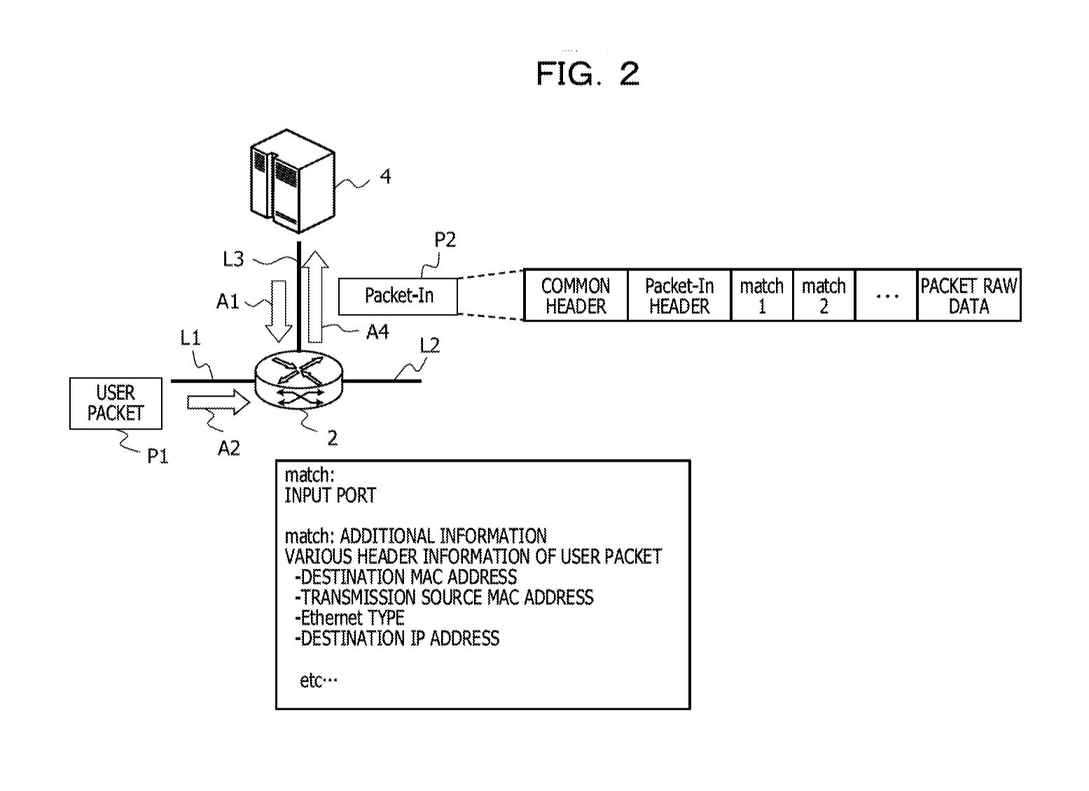

FIG. 3 is a diagram for explaining an example of a communication method according to an embodiment;

FIG. 4 is a diagram for explaining an example of a configuration of a communication device;

FIG. 5 is a diagram for explaining an example of a configuration of a control device;

FIG. 6 is a diagram for explaining an example of hardware configurations of the communication device and the control device;

FIG. 7 is a diagram for explaining an example of a communication system;

FIG. 8 is a diagram for explaining an example of a notification information table;

FIG. 9 is a diagram for explaining an example of a notification information setting message;

FIG. 10 is a diagram for explaining an example of a setting of notification information;

FIG. 11 is a diagram for explaining an example of processing in a case where the notification information is set;

FIG. 12 is a diagram for explaining an example of authentication processing;

FIG. 13 is a diagram for explaining an example of transfer processing of data packets;

FIG. 14 is a flowchart for explaining an example of processing in the control device;

FIG. 15 is a flowchart for explaining an example of processing in the communication device that receives the notification information setting message;

FIG. 16 is a flowchart for explaining an example of processing in the communication device at a time of requesting a processing rule; and

FIG. 17 is a diagram for explaining an example of reduction of information transmitted and received between the control device and the communication device.

### DESCRIPTION OF EMBODIMENTS

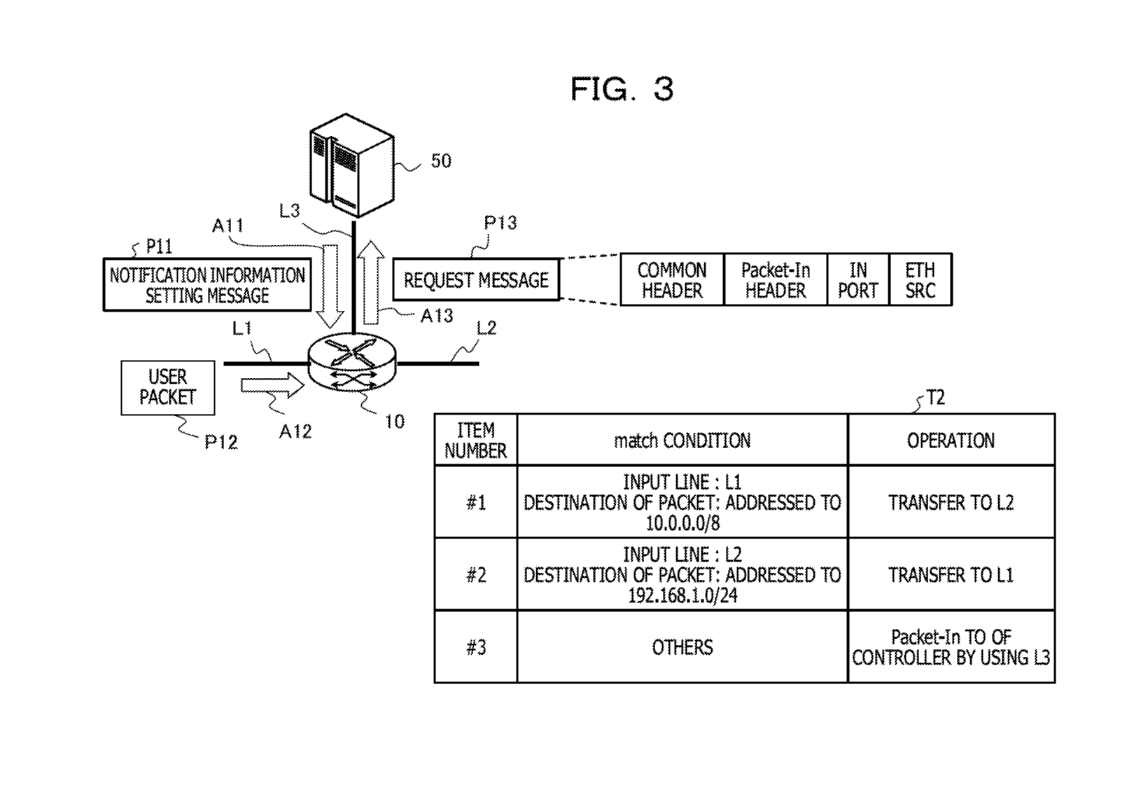

FIG. 3 is a diagram for explaining an example of a communication method according to an embodiment. A network illustrated in FIG. 3 includes a control device 50 and a communication device 10. The control device 50 operates as an OF controller, and the communication device 10 operates as an OF switch. Hereinafter, a message used for requesting a processing rule from the control device 50 is described as a “request message” in some cases. A Packet-In message is an example of the request message. In some cases, packets received from devices other than the control device 50 by the communication device 10 are described as “user packets” in order to discriminate the user packets from packets used for communication between the communication device 10 and the control device 50. The user packets are packets of arbitrary kinds received from devices other than the control device 50 by the communication device 10.

In an arrow A11, the control device 50 transmits a notification information setting message P11 to the communication device 10 within the network. The notification information setting message P11 includes requesting, from the control device 50 via a control line L3, a processing rule for a packet to which none of processing rules held by the communication device 10 is applied, and information elements to be given notice of at a time of requesting the processing rule. As information for identifying the information elements to be given notice of at a time of requesting the processing rule, a combination of characteristic information indicating a characteristic of the corresponding one of the user packets and information elements to be used by the control device 50 to determine a processing method to be performed by the communication device 10 on a packet having the characteristic information may be used. In the example of FIG. 3, in the notification information setting message P11, as information elements serving as notification targets, an input port (IN_PORT) of a packet for which a processing rule is requested and a transmission source MAC address (ETH_SRC) of the packet for which the processing rule is requested are specified.

Upon receiving the notification information setting message P11, the communication device 10 stores information of the notification information setting message P11. Information included in, for example, the notification information setting message P11 may be stored in a flow table along with another processing rule. In this case, the degree of priority of an entry including the information received by using the notification information setting message P11 is lower than other processing rules. A table T2 is an example of a flow table stored in the communication device 10. An entry of an item number #3, included in the flow table T2, is information given notice of by the notification information setting message P11. On the other hand, pieces of information included in an entry of an item number #1 and an entry of an item number #2 are pieces of information obtained from FlowMod or the like used for a notification of a processing rule without using the notification information setting message. Since information of an entry having a smaller value of the item number is preferentially used, processing in the entry of the item number #3 is applied to a packet to which none of the entry of the item number #1 and the entry of the item number #2 is applied.

It is assumed that, in an arrow A12, the communication device 10 receives a user packet P12 via a data line L1. A destination of the user packet P12 does not correspond to 10.0.0.0/8. Then, the communication device 10 determines that processing in the entry of the item number #1 in the flow table T2 is not to be applied. Next, since the user packet P12 is received from the data line L1, the communication device 10 determines that processing in the entry of the item number #2 in the flow table T2 is not to be applied. Therefore, in accordance with the information of the entry of the item number #3, the communication device 10 generates a request message P13 including, as information of a packet for which a processing rule is requested, an input port number at a time of receiving the user packet P12, and the transmission source MAC address of the user packet P12. At this time, the communication device 10 omits, from the request message P13, information that is not specified in the entry of the item number #3 and that is included in data within the user packet P12. Therefore, the request message P13 does not include information that is included in the user packet P12 and that is other than information used for determining a processing rule. In a case where a Packet-In message is used as the request message P13, the request message P13 includes a common header, a Packet-In header, an input port (IN_PORT), and a transmission source MAC address (ETH_SRC), as illustrated in FIG. 3. As illustrated in an arrow A13, the request message P13 is transmitted to the control device 50 by the communication device 10.

Upon receiving the request message P13, the control device 50 determines, by using information elements included in the request message P13, a processing rule in the communication device 10, which is related to a packet serving as a trigger of transmission of the request message P13.

In this way, in a method according to an embodiment, the communication device 10 is able to acquire the information elements to be used by the control device 50 to determine the processing rule while associating the information elements with characteristic information indicating characteristics of a user packet. Regarding a packet for which a processing rule is inquired, by using a preliminarily acquired correspondence relationship, the communication device 10 causes information elements, which are to be used by the control device 50 to determine the processing rule, to be included in a request message addressed to the control device 50. Therefore, the communication device 10 that inquires the processing rule is able to inhibit data, which is not to be used by the control device 50 to determine the processing rule, from being transmitted to the control device 50. In addition, it is possible to reduce the amount of data communication between the communication device 10 and the control device 50.

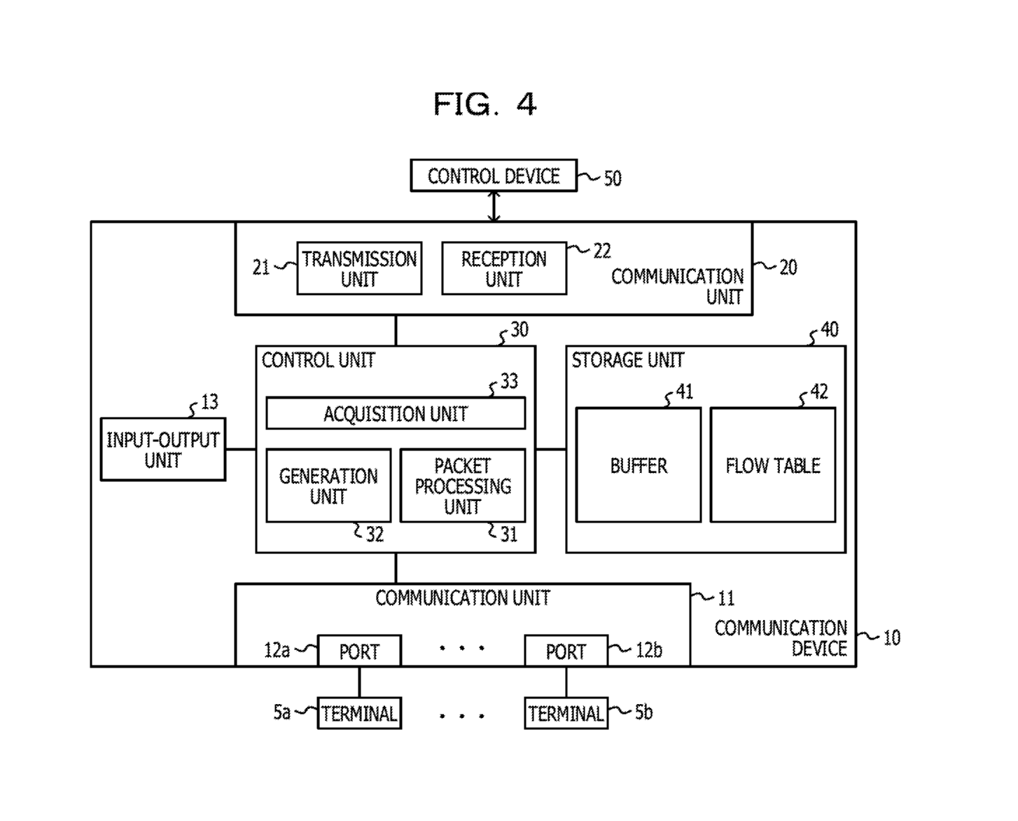

FIG. 4 is a diagram for explaining an example of a configuration of the communication device 10. The communication device 10 includes a communication unit 11, a communication unit 20, a control unit 30, and a storage unit 40. The communication device 10 may include an input-output unit 13 as an optional extra. The communication unit 20 includes a transmission unit 21 and a reception unit 22. The control unit 30 includes a packet processing unit 31, a generation unit 32, and an acquisition unit 33. The storage unit 40 operates as a buffer 41 and further stores therein a flow table 42.

The communication unit 11 includes ports 12 (12a, 12b) used at a time of transferring packets to other devices such as terminals 5 (5a, 5b). A data line is coupled to each of the ports 12. The input-output unit 13 operates as an input device used by an operator for input processing or an output device used by the operator to visually recognize a processing result.

The communication unit 20 performs communication processing between the communication device 10 and the control device 50, via the control line L3. The transmission unit 21 transmits, to the control device 50, control packets such as request messages. On the other hand, the reception unit 22 receives control packets from the control device 50. The reception unit 22 outputs a received control packet to the acquisition unit 33. The acquisition unit 33 processes the input control packet and arbitrarily updates the flow table 42. Upon acquiring the packet received by the communication unit 11, the generation unit 32 searches, within the flow table 42, a processing rule to be applied to the reception packet. In a case where transmitting a request message to the control device 50 is associated with the characteristic information of the reception packet, the generation unit 32 generates a request message including information elements associated with the characteristic information of the reception packet. At this time, the generation unit 32 arbitrarily stores the reception packet in the buffer 41. In a case where a processing rule for specifying processing other than transmission of a request message to the control device 50 is applied to the reception packet, the generation unit 32 outputs the obtained processing rule to the packet processing unit 31 along with the packet serving as a processing target. In accordance with the processing rule input by the generation unit 32, the packet processing unit 31 processes the packet.

FIG. 4 graphically illustrates one of the flow tables 42. However, the number of the flow tables 42 held by the communication device 10 may be arbitrarily changed in response to an implementation. In the same way, the number of the ports 12 included in the communication device 10, the number of the terminals 5 that communicate with the communication device 10, and so forth are arbitrary.

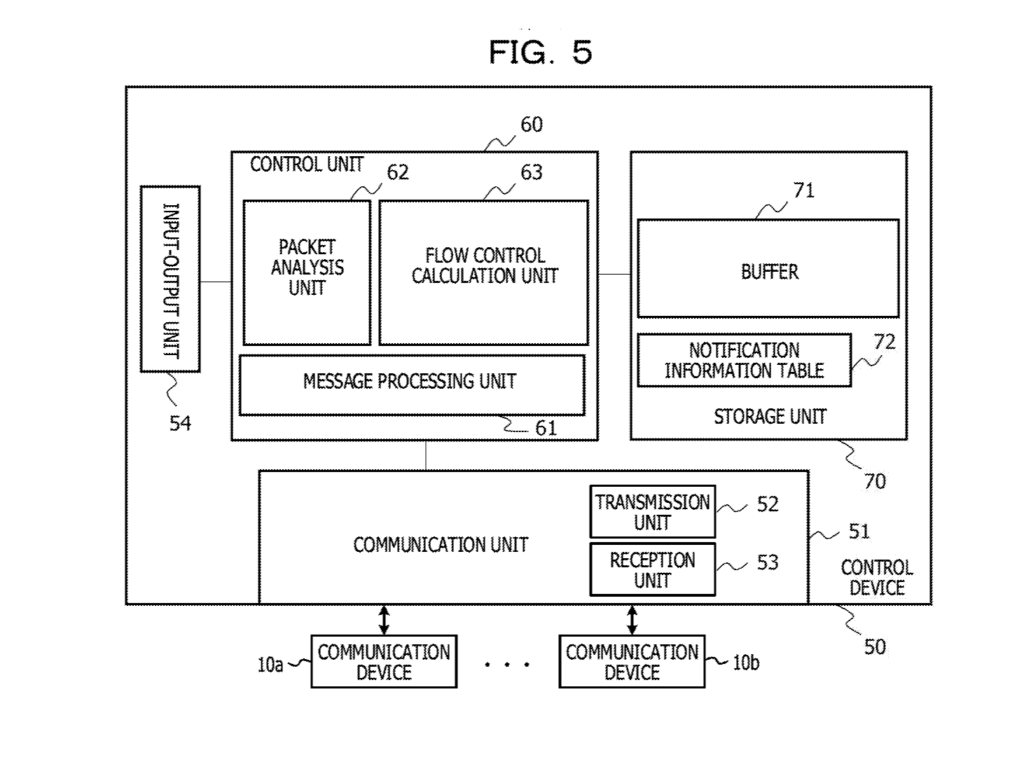

FIG. 5 is a diagram for explaining an example of a configuration of the control device 50. The control device 50 includes a communication unit 51, a control unit 60, and a storage unit 70. The control device 50 may include an input-output unit 54 as an optional extra. The communication unit 51 includes a transmission unit 52 and a reception unit 53. The control unit 60 includes a message processing unit 61, a packet analysis unit 62, and a flow control calculation unit 63. The storage unit 70 operates as a buffer 71 and further stores therein information such as a notification information table 72.

The transmission unit 52 transmits control packets to the communication device 10. On the other hand, the reception unit 53 receives control packets such as request messages from the communication device 10. The reception unit 53 outputs a received control packet to the message processing unit 61. In accordance with a processing state of the message processing unit 61, the reception unit 53 may output a control packet to the buffer 71. The input-output unit 54 operates as an input device used by an operator of the control device 50 for input processing or an output device used by the operator to visually recognize a processing result.

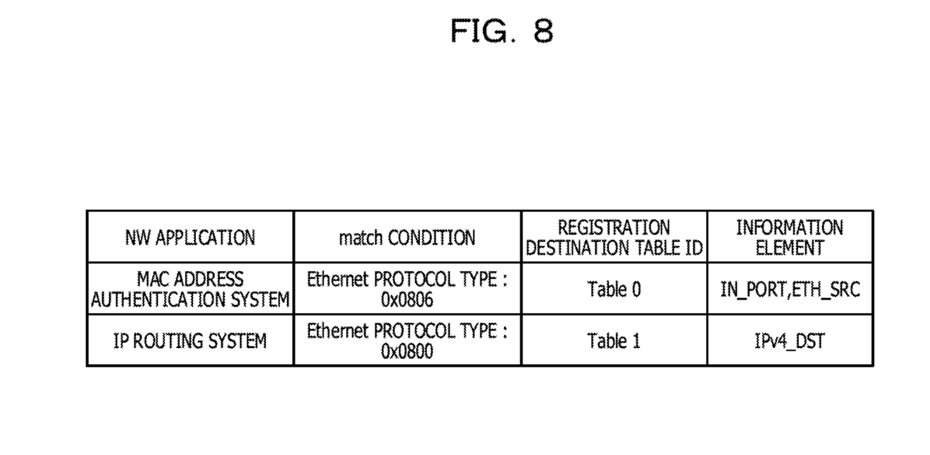

The notification information table 72 holds information that is preliminarily set by the operator or the like and that is included in processing rules to be set in the communication device 10 by the control device 50. In the notification information table 72, kinds of information to be used by the control device 50 at a time of determining a processing rule are recorded while being associated with information (characteristic information) indicating characteristics included in a packet serving as a target for which a processing rule is inquired, for example. The characteristic information is information used for classification of packets. The characteristic information may be used as, for example, a match condition of the Openflow. The notification information table 72 may include a processing rule other than processing rules to be used for settings of pieces of information given notice of by request messages. An example of the notification information table 72 will be described later (FIG. 8).

Upon generating, by using the notification information table 72 or preliminarily stored information, a control packet for notifying the communication device 10 within the system of information to be used at a time of determining a processing rule, the message processing unit 61 transmits the control packet via the transmission unit 52. On the other hand, in a case where the control device 50 receives a packet, the message processing unit 61 processes an input control packet and outputs information, given notice of, to the packet analysis unit 62 or the flow control calculation unit 63. In a case where the control message includes a packet received from another device by the communication device 10 serving as a transmission source of the control message, the packet analysis unit 62 analyzes the packet. In addition, the packet analysis unit 62 outputs obtained information to the flow control calculation unit 63. By using information stored in the storage unit 70, the flow control calculation unit 63 performs calculation processing for performing flow control. The flow control calculation unit 63 may perform processing based on 1 network application. The flow control calculation unit 63 may perform processing based on network applications. Furthermore, all or part of processing in the flow control calculation unit 63 may be performed by an application server coupled to the control device 50. In conformity with a processing result obtained by the flow control calculation unit 63, the message processing unit 61 generates a control message for giving notice to the communication device 10. In addition, the message processing unit 61 transmits to the communication device 10 via the transmission unit 52.

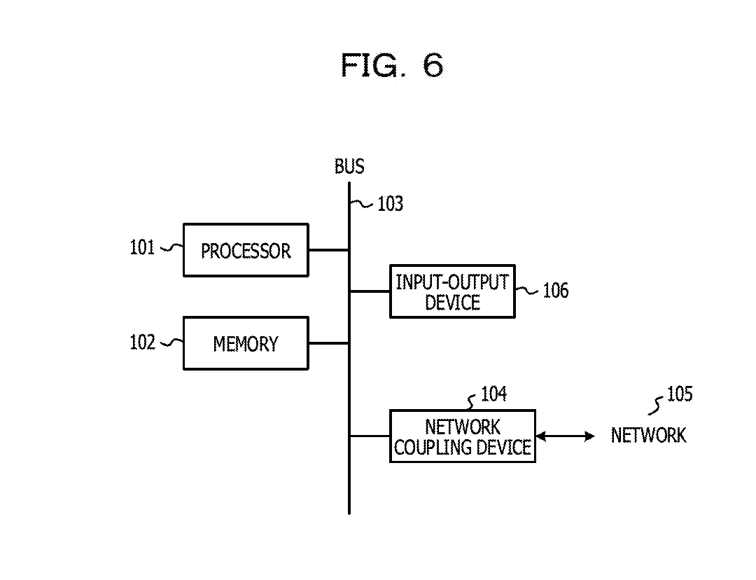

FIG. 6 is a diagram for explaining an example of hardware configurations of the communication device 10 and the control device 50. The communication device 10 and the control device 50 each include a processor 101, a memory 102, a bus 103, and a network coupling device 104 and each further include an input-output device 106 as an optional extra. The bus 103 couples the processor 101, the memory 102, the network coupling device 104, and the input-output device 106 so that the processor 101, the memory 102, the network coupling device 104, and the input-output device 106 become able to transmit and receive data to and from one another. The processor 101 may be one of arbitrary processors including a central processing unit (CPU). The memory 102 includes a random access memory (RAM) and a read only memory (ROM). The memory 102 operates as a buffer and further records therein information to be used for processing in the processor 101, information obtained by the processing in the processor 101, or the like. The memory 102 stores therein a program to be executed by the processor 101. The input-output device 106 is an input device such as a keyboard used by an operator at a time of performing input processing, an output device for outputting a processing result in the processor 101 so that the operator is able to visually recognize the processing result, or the like. The output device may be, for example, a display or the like. The network coupling device 104 performs communication with a network 105.

In the communication device 10, the processor 101 realizes the control unit 30. The memory 102 operates as, for example, the storage unit 40. The network coupling device 104 realizes the communication unit 11 and the communication unit 20 and further includes the ports 12. The input-output device 106 operates as the input-output unit 13.

In the control device 50, the processor 101 realizes the control unit 60. The memory 102 operates as, for example, the storage unit 70. The network coupling device 104 realizes the communication unit 51. Furthermore, the input-output device 106 operates as the input-output unit 54.

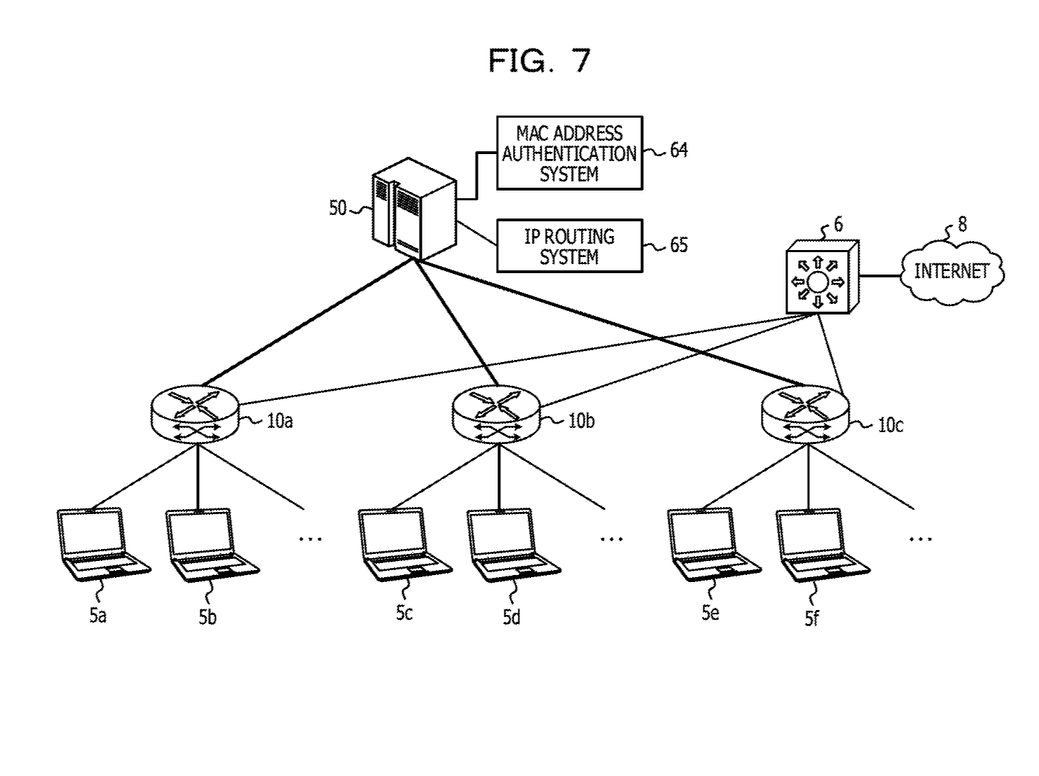

FIG. 7 is a diagram for explaining an example of a communication system. A communication system illustrated in FIG. 7 includes the control device 50, the communication devices 10 (10a to 10c), a MAC address authentication system 64, an IP routing system 65, and a router 6. The router 6 is coupled to the Internet 8. Each of the devices of the communication devices 10a to 10c is coupled to the router 6 and the control device 50. Thick lines in FIG. 7 are used for transmission and reception of control messages and so forth. Thin lines are used for transmission and reception of pieces of data such as user packets. The terminals 5 (5a to 5f) are able to communicate with other devices via the communication devices 10. The terminal 5a and the terminal 5b are coupled to the communication device 10a, and the terminal 5c and the terminal 5d are coupled to the communication device 10b. Furthermore, the terminal 5e and the terminal 5f are coupled to the communication device 10c. In the system in FIG. 7, each of the communication devices 10a to 10c is a device to process packets in accordance with processing rules acquired from the control device 50 and operates as an Openflow switch. On the other hand, the router 6 is a switch, not controlled by the control device 50, and may be, for example, a core switch. A combination of the control device 50, the MAC address authentication system 64, and the IP routing system 65 operates as an Openflow controller.

FIG. 7 is an example of the system, and the number of, for example, the terminals 5 or the communication devices 10 within the system is arbitrary. The number of the terminals 5 coupled to each of the communication devices 10 is arbitrary. While FIG. 7 graphically illustrates an example in a case where the MAC address authentication system 64 and the IP routing system 65 are realized by a server or the like coupled to the control device 50, this is just an example. The MAC address authentication system 64 or the IP routing system 65 may be realized by, for example, the flow control calculation unit 63 within the control device 50. In the MAC address authentication system 64, authentication processing that utilizes a MAC address of a user who performs communication by using the communication system is performed. On the other hand, in a case where one of the communication devices 10 requests processing rules for packets transmitted and received by one of the terminals 5 to and from communication destinations, the IP routing system 65 performs path calculation.

Hereinafter, after describing an example of communication performed in the system illustrated in FIG. 7, separately divided into a setting of information of which one of the communication devices 10 notifies the control device 50, authentication processing of an MAC address, and transfer processing of data packets, an operation of each of devices will be described in chronological order.

(1) Setting of Information of which Communication Device 10 Notifies Control Device 50

With reference to the notification information table 72 the control device 50 generates a control packet for notifying one of the communication devices 10 of information elements to be included in a request message addressed to the control device 50 at a time of an inquiry about a processing rule. Hereinafter, a control packet for giving notice of information elements to be included in a request message will be described as a “notification information setting message”, in some cases. The information elements of which the notification information setting message notifies the corresponding one of the communication devices 10 are information elements used for determination of the processing rule inquired by the request message. Furthermore, in the following description, a case where the communication devices 10 each hold the flow tables 42 will be described as an example. The control device 50 and the communication devices 10 use pieces of identification information (table IDs) for uniquely identifying the respective flow tables 42 within the communication devices 10. Hereinafter, it is assumed that each of the table IDs is expressed by a character string obtained by a character string of “Table” followed by numeric characters. Furthermore, in each of the communication devices 10, the flow table 42 of the table ID=“Table 0” is taken on top priority, and the other flow tables 42 are arbitrarily referenced in accordance with records within the table ID=“Table 0”.

FIG. 8 is a diagram for explaining an example of the notification information table 72. In the notification information table 72, a network (NW) application, a match condition, a registration destination table ID, and information elements are associated with one another. The network application is the kind of an application to be used for determination of a processing rule for a packet identified by the match condition within a corresponding entry. The network application may be an application to process information within the packet identified by the match condition within the corresponding entry. The registration destination table ID is identification information of the flow table 42 to serve as a storage destination of information given notice of by a notification information setting message. The information given notice of by the notification information setting message is information to be included in a request message that requests a processing rule to be applied to the packet identified by the match condition within the corresponding entry, and may be said to be a processing rule for generating the request message. The information elements are information elements used for processing in the network application at a time of determining the processing rule for the packet identified by the match condition within the corresponding entry. In other words, the control device 50 requests the corresponding one of the communication devices 10 to give notice of information elements within the notification information table 72 at a time of requesting the processing rule for the packet identified by the match condition within the corresponding entry.

In a first entry in FIG. 8, an application to be used for determination of a processing rule for a packet of an Ethernet protocol type=“0x0806” or information elements to be used for the determination of the processing rule are recorded. The packet of the Ethernet protocol type=“0x0806” is an address resolution protocol (ARP) packet. Processing for information such as a transmission source MAC address within the ARP packet is performed by the MAC address authentication system 64. A processing rule to be referenced by the corresponding one of the communication devices 10 at a time of requesting a processing rule for the ARP packet is registered in the flow table 42 of the table ID=“Table 0”. Furthermore, pieces of information to be included in a request message in a case where the corresponding one of the communication devices 10 requests the processing rule for the ARP packet are an input port (IN_PORT) of the ARP packet and a transmission source MAC address (ETH_SRC) of the ARP packet.

A second entry in FIG. 8 holds an application to be used for determination of a processing rule for a packet of the Ethernet protocol type=“0x0800” or information elements to be used for the determination of the processing rule. The packet of the Ethernet protocol type=“0x0800” is an Internet protocol version 4 (IPv4) packet. Information within the IPv4 packet is processed by the IP routing system 65. A processing rule to be referenced by the corresponding one of the communication devices 10 at a time of requesting a processing rule for the IPv4 packet is registered in the flow table 42 of the table ID=“Table 1”. Furthermore, information to be included in a request message in a case where the corresponding one of the communication devices 10 requests the processing rule for the ARP packet is a destination IP address of the IPv4 packet (IPv4_DST).

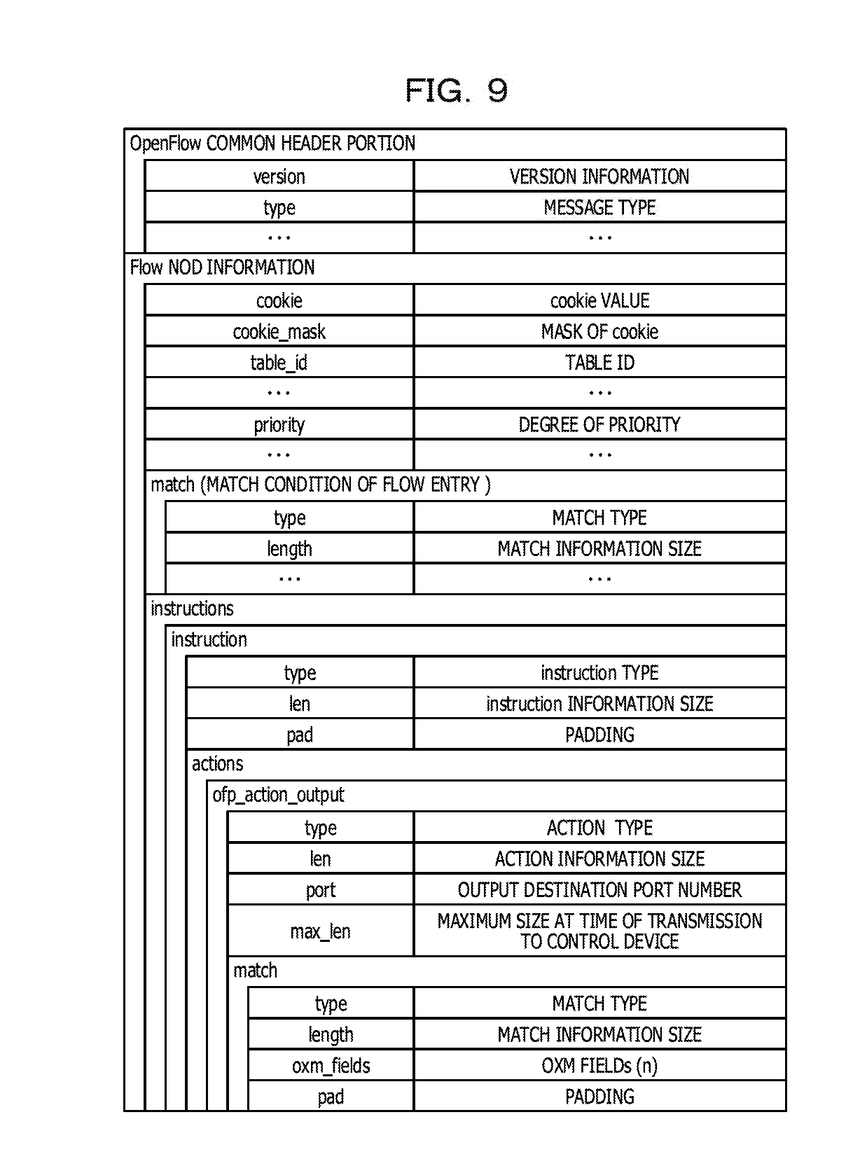

FIG. 9 is a diagram for explaining an example of a notification information setting message. FIG. 9 illustrates an example in a case where the notification information setting message is realized as a FlowMod message of the Openflow. In the example of FIG. 9, by using an OpenFlow eXtensible Match (OXM) header, the corresponding one of the communication devices 10 is notified of information of which the corresponding one of the communication devices 10 notifies the control device 50 by using a request message.

The notification information setting message includes a common header portion and FlowMod information. The common header portion includes an OpenFlow version applied to the control device 50 serving as a transmission source of the notification information setting message, and a message type (type). The FlowMod information includes a cookie value, a cookie_mask, a table_id, a priority, a match condition, and instructions. The cookie value is a value to be used in a case where the control device 50 specifies a flow entry. The cookie_mask is a mask of the cookie value. The table_id is a table ID for specifying the flow table 42 that is to serve as a storage destination of a processing rule given notice of by the notification information setting message and that is included in the communication device 10 to serve as a destination of the notification information setting message. The priority is the degree of priority in accordance with which the processing rule given notice of by the notification information setting message is applied. The degree of priority of the processing rule given notice of by the notification information setting message is set so as to become lower than other conditions within the same table as that of the processing rule given notice of by the notification information setting message, for example. In this case, the processing rule given notice of by the notification information setting message is applied to a packet that meets none of conditions within the flow table 42. The match condition includes a match type (type) and a match information size (length). In FIG. 9, part of information within the match condition is omitted. However, pieces of information set, as the match condition, in the corresponding one of the flow tables 42 are stored in the fields of the match condition.

The instructions are pieces of information for giving notice of a processing content of a packet. The instructions may include an instruction field and 1 or more actions. The instruction field includes the type (type) of an instruction and the size (len) of instruction information and arbitrarily includes padding.

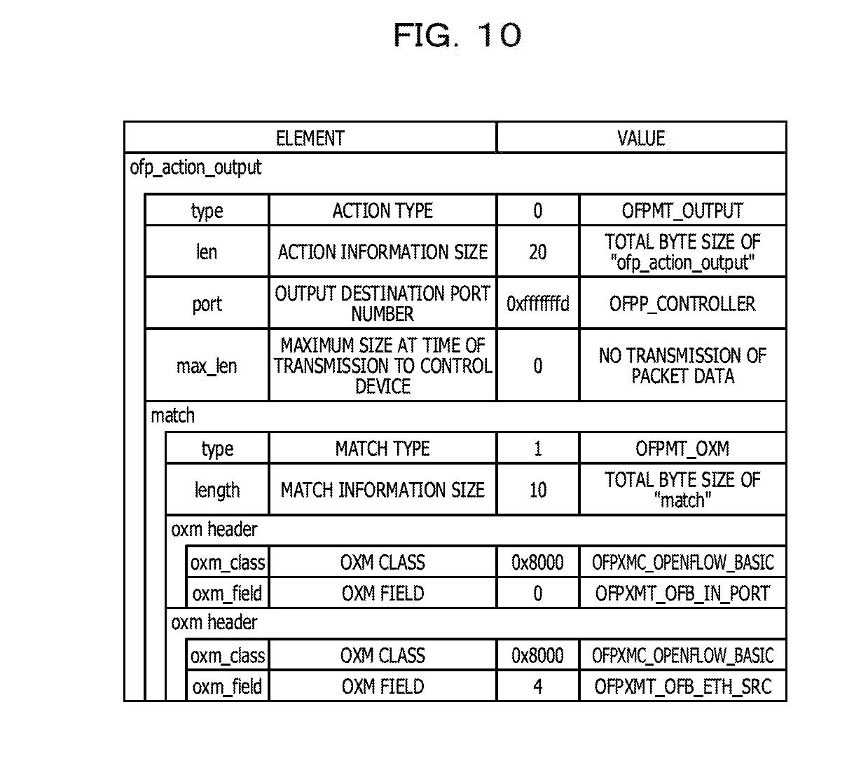

The notification information setting message includes, as an action, an output action (ofp_action_output). The ofp_action_output includes the type (type) of an action, the size (len) of action information, an output destination port number (port), a max_len, and so forth. Here, the max_len is a maximum size of a packet that serves as an inquiry target and that is transmitted to the control device 50 in a case where the corresponding one of the communication devices 10 causes the packet serving as a target, for which a processing rule is inquired, to be included in a request message. Furthermore, in the ofp_action_output, pieces of information for identifying information of which the control device 50 is to be notified are recorded as the match condition. In the example of FIG. 9, as the match condition used for identifying the pieces of information for identifying information of which the control device 50 is to be notified, a match type, a match information size, an OXM field, and padding are included. An example of a specific setting of the output action (ofp_action_output) will be described with reference to FIG. 10.

FIG. 10 is a diagram for explaining an example of a setting of notification information in a notification information setting message. FIG. 10 illustrates an example of a setting of individual information elements included in the ofp_action_output and values of the information elements in a case where the notification information setting message is generated in accordance with the first entry in FIG. 8. In FIG. 10, a value of a type field indicating an action type is set to “0”. The type field=“0” indicating the action type indicates that the action type is OFPMT_OUTPUT. The action information size (len) is obtained by expressing a field length of the entire ofp_action_output in units of bytes. In the example of FIG. 10, it is 20 bytes. In a port field, “0xfffifffd” is recorded as the output destination port number. In the communication device 10 to serve as a destination of the notification information setting message, the port number=“0xfffffffd” is the number of a port (ofpp_controller) coupled to the control device 50. The max_len is a data amount that is contained in a request message and that is included in a packet serving as a target for which a processing rule is inquired. In the example of FIG. 10, it is set to the max_len=“0”. Therefore, in the setting illustrated in FIG. 10, at a time of inquiring a processing rule of the control device 50, the corresponding one of the communication devices 10 does not transfer, to the control device 50, the packet serving as a trigger of requesting the processing rule.

Next, an example of a setting of the match condition will be described. In the example of FIG. 10, a value of a type field indicating the match condition is set to “1”. The type field=“1” indicating the match condition indicates that the match condition is OFPMT_OXM. The match information size (length) is obtained by expressing a field length of the match condition in units of bytes. In the example of FIG. 10, it is set to 10 bytes. The match condition includes an arbitrary number of OXM headers. Here, the OXM headers each include an OXM class (oxm_class) and an OXM field (oxm_field). In each of the OXM headers, information of which the corresponding one of the communication devices 10 notifies the control device 50 by using a request message is recorded.

In, for example, a first OXM header, the oxm_class=“0x8000” and the oxm_field=“0” are recorded. Here, the oxm_class=“0x8000” indicates OFPXMC_OPENFLOW_BASIC, and the oxm_field=“0” indicates OFPXMT_OFB_IN_PORT. Therefore, in the first OXM field in FIG. 10, as information to be included in a request message from the corresponding one of the communication devices 10 to the control device 50, an input port of the packet serving as a target for which the processing rule is inquired is set. On the other hand, in a second OXM header, the oxm_class=“0x8000” and the oxm_field=“4” are recorded. Here, the oxm_field=“4” indicates OFPXMT_OFB_ETH_SRC. Therefore, in the second OXM field in FIG. 10, as information to be included in a request message from the corresponding one of the communication devices 10 to the control device 50, a transmission source MAC address of the packet serving as a target for which the processing rule is inquired is set.

In a case where, in accordance with another entry in the notification information table 72 or information stored in the control device 50, the corresponding one of the communication devices 10 is notified of information to be included in a request message, a notification information message having the same format as the format described with reference to FIG. 9 and FIG. 10 is used.

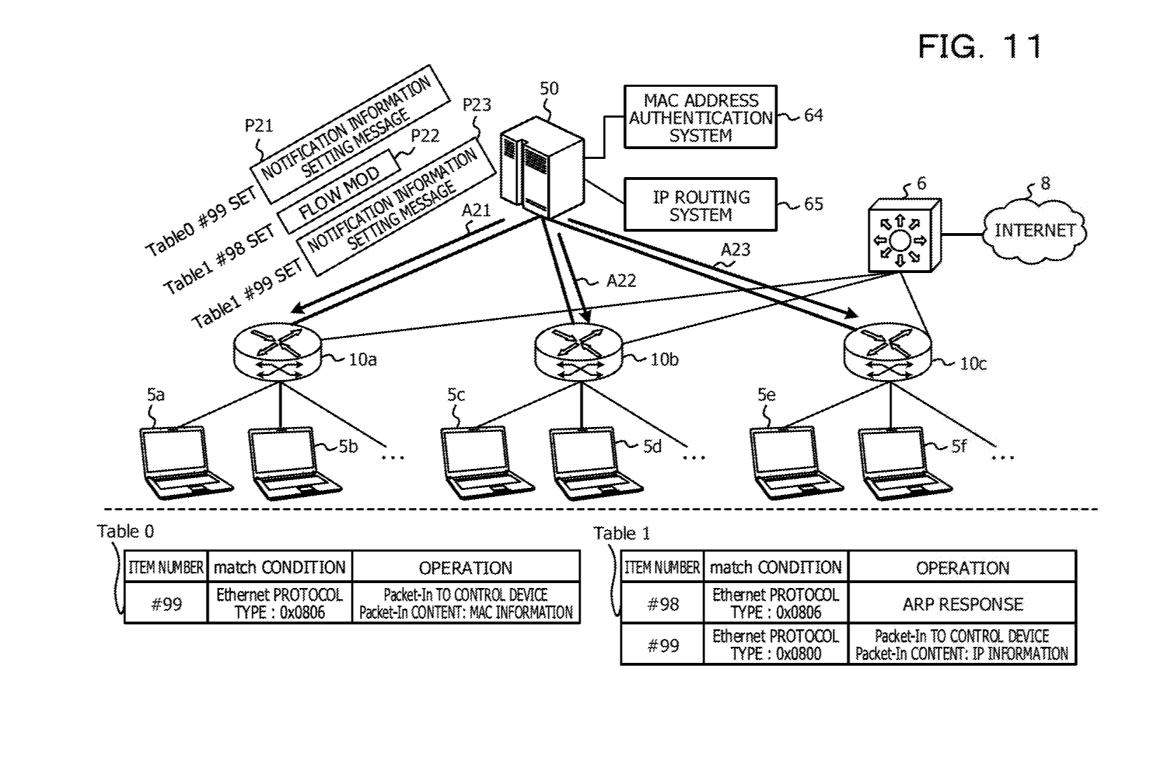

FIG. 11 is a diagram for explaining an example of processing in a case where the notification information is set. The message processing unit 61 references the condition of the first entry of the notification information table 72 illustrated in FIG. 8, thereby generating the notification information setting message including information elements illustrated in FIG. 9 or FIG. 10. It is assumed that the notification information setting message for setting, in the corresponding one of the communication devices 10, the condition of the first entry of the notification information table 72 illustrated in FIG. 8 is a packet P21. In other words, the packet P21 notifies the corresponding one of the communication devices 10 of transmitting Packet-In to the control device 50 in a case where an ARP packet is received and of causing an input port and a transmission source MAC address to be included in the Packet-In. Accordingly, regarding an ARP packet from the corresponding one of the terminals 5, the corresponding one of the communication devices 10 inquires processing of the control device 50.

In the example of FIG. 11, the message processing unit 61 specifies an item number #99 in Table 0, as a storage location of information within the packet P21. A value of an item number used for storing information is given notice of by using Priority. In the following description, in the corresponding one of the communication devices 10, match of information of a packet is performed in ascending order of a value of the item number. Therefore, the degree of priority decreases with an increase in the value of the item number.

Next, a FlowMod message for requesting to transmit an ARP response to an ARP packet is generated, as a packet P22, by the message processing unit 61. The format of the packet P22 is the same as that of a standard FlowMod message of the Openflow. The message processing unit 61 specifies, as a storage location of information within the packet P22, an item number #98 in Table 1. The message of the packet P22 is used for avoiding performing authentication processing on the same terminal 5 in a duplicated manner. A method for avoiding duplication of the authentication processing will be described later.

Furthermore, the message processing unit 61 references the condition of the second entry of the notification information table 72 illustrated in FIG. 8, thereby generating the notification information setting message illustrated in a packet P23. At this time, the message processing unit 61 specifies an item number #99 in Table 1, as a storage location of information within the packet P23. The packet P23 notifies the corresponding one of the communication devices 10 of transmitting Packet-In to the control device 50 in a case where an IP packet for which no processing rule is determined is received and of causing a destination IP address to be included in the Packet-In.

The message processing unit 61 outputs the generated packets P21 to P23 to the transmission unit 52. The transmission unit 52 transmits the packets P21 to P23 to the communication device 10a (arrow A21). Then, the reception unit 22 in the communication device 10a receives the packets P21 to P23 and outputs the packets to the acquisition unit 33. The acquisition unit 33 records, in the item number #99 in Table 0, processing given notice of by the packet P21. Therefore, in Table 0 in the communication device 10a, information in Table 0, graphically illustrated in FIG. 11, is recorded. Accordingly, transmitting, upon receiving a packet of the Ethernet protocol type=“0x0806”, Packet-In including an input port and a transmission source MAC address of the reception packet to the control device 50 is recorded in the corresponding one of the flow tables 42 in the communication device 10a. In drawings subsequent to FIG. 11, due to limitations of space, an input port and a transmission source MAC address will be collectively described as “MAC information” in some cases.

Upon acquiring the packet P22 via the reception unit 22, the acquisition unit 33 in the communication device 10a records, in the item number #98 in Table 1, information within the packet P22. Furthermore, upon acquiring the packet P23, the acquisition unit 33 in the communication device 10a records, in the item number #99 in Table 1, information within the packet P23. Therefore, after the processing of the packet P22 and the packet P23, information in Table 1, graphically illustrated in FIG. 11, is recorded in Table 1 in the communication device 10a. In drawings subsequent to FIG. 11, due to limitations of space, a destination IP address will be described as “IP information” in some cases.

The transmission unit 52 in the control device 50 further transmits the packets P21 to P23 to the communication device 10b and the communication device 10c (arrows A22 and A23). Then, the same processing as that in the communication device 10a is performed in each of the communication device 10b and the communication device 10c. Therefore, in each of the communication devices 10, pieces of information in Table 0 and Table 1 become as illustrated in FIG. 11.

(2) Authentication Processing of MAC Address

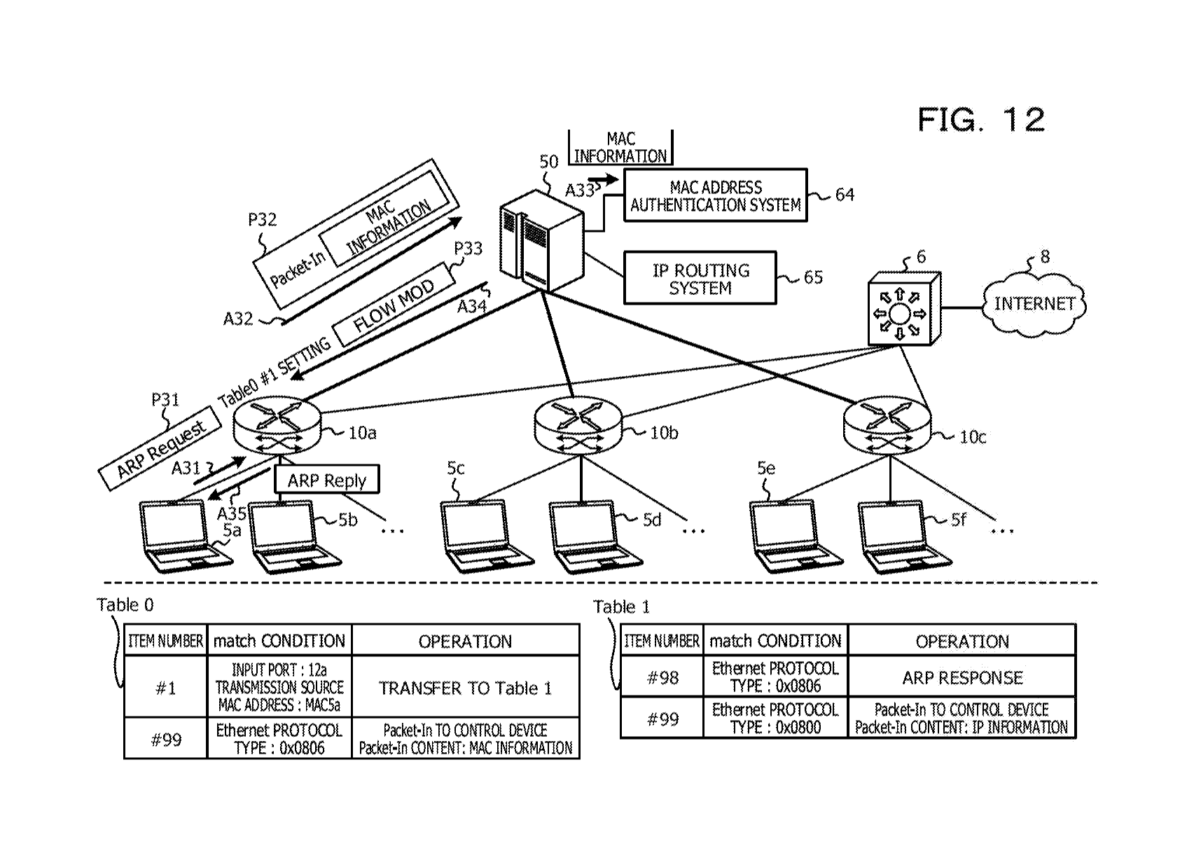

FIG. 12 is a diagram for explaining an example of authentication processing. At a point of time of starting communication processing illustrated in FIG. 12, the communication devices 10a to 10c each hold, as the flow tables 42, Table 0 and Table 1 illustrated in FIG. 11. At a point of time of starting the communication processing illustrated in FIG. 12, the terminal 5a does not yet perform communication via the communication device 10a.

In an arrow A31, the terminal 5a transmits a packet P31 to the communication device 10a. Hereinafter, the packet P31 is an ARP Request generated by the terminal 5a in order to perform communication with a device within the Internet 8. The communication unit 11 in the communication device 10a receives the packet P31 via the port 12a. The communication unit 11 outputs the packet P31 to the generation unit 32. The generation unit 32 searches within the corresponding one of the flow tables 42 in order to identify processing to be applied to the packet P31. Since being an ARP Request, the packet P31 is a packet of the Ethernet protocol type=“0x0806”. Therefore, the generation unit 32 determines that the condition of the item number #99 in Table 0 illustrated in FIG. 11 is to be applied. The generation unit 32 generates a Packet-In message (packet P32) for inquiring processing of the packet P31. The following pieces of information are included in the packet P32 as MAC information. However, none of other pieces of information within the packet P31 are included therein.

Input Port: Port 12a

Transmission Source MAC Address: MAC5a (MAC Address of Terminal 5a)

In other words, the generation unit 32 excludes, from targets to be included in the Packet-In message, information that is not specified in the entry of the item number #99 in Table 0 and that is included in the packet P31. The generation unit 32 transmits the generated Packet-In message to the control device 50 via the transmission unit 21 (arrow A32).

Upon receiving the Packet-In message of the packet P32, the reception unit 53 in the control device 50 outputs to the message processing unit 61. Since the packet P32 is the Packet-In message for inquiring a processing rule, the message processing unit 61 outputs the packet P32 to the flow control calculation unit 63. Since the packet P32 includes the MAC information, the flow control calculation unit 63 determines that processing for a packet from the terminal 5 for which no authentication of a MAC address is performed is inquired. Therefore, the flow control calculation unit 63 determines that the MAC address authentication system 64 is to be requested to perform authentication processing of a MAC address of a transmission source of the packet (packet P31) for which processing is inquired by the packet P32. The flow control calculation unit 63 extracts the MAC information included in the packet P32 and requests the MAC address authentication system 64 to perform the authentication processing (arrow A33).

The MAC address authentication system 64 preliminarily holds information of MAC addresses of devices to be permitted to perform communication via the communication devices 10a to 10c. In order to permit communication of a device that succeeds in authentication, the MAC address authentication system 64 notifies the control device 50 of a result of the authentication. In the example of FIG. 12, the authentication processing in the MAC address authentication system 64 succeeds. The MAC address authentication system 64 notifies the flow control calculation unit 63 of a success in the authentication processing.

In a case where the authentication processing of a MAC address succeeds, the flow control calculation unit 63 generates a processing rule for permitting communication, in order to avoid multiple authentication of a packet transmitted by the same device. In the example of FIG. 12, in a case where the communication device 10a receives, from the port 12a, a packet of the transmission source MAC address=MAC5a, the flow control calculation unit 63 generates a FlowMod message for requesting to reference a processing rule within Table 1 (packet P33). At this time, the flow control calculation unit 63 determines an item number to be used for registration of a condition given notice of by the packet P33 so that, in the communication device 10a, the condition given notice of by the packet P33 has the higher degree of priority than a condition used for the authentication processing. Here, the flow control calculation unit 63 generates the FlowMod message so that the condition of the packet P33 is registered in an item number #1 in Table 0. The flow control calculation unit 63 transmits the packet P33 to the communication device 10a via the transmission unit 52 (arrow A34).

Upon receiving the packet P33, the reception unit 22 in the communication device 10a outputs the packet P33 to the acquisition unit 33. In accordance with a specification in the packet P33, the acquisition unit 33 registers information included in the packet P33, in the item number #1 in Table 0 within the corresponding one of the flow tables 42 included in the communication device 10a. Therefore, information of the corresponding one of the flow tables 42 held by the communication device 10a is revised from the information illustrated in FIG. 11 to such information as illustrated in FIG. 12.

Since the packet P33 is a packet received as a response to the Packet-In message illustrated in the packet P32, the acquisition unit 33 notifies the generation unit 32 of a processing rule given notice of by the packet P33. By using the processing rule given notice of, the generation unit 32 searches, within Table 1, for a processing rule applicable to the packet P31. Here, since being an ARP Request, the packet P31 is a packet of the Ethernet protocol type=“0x0806”. Therefore, the generation unit 32 determines that the condition of the item number #98 in Table 1 illustrated in FIG. 12 is to be applied. In the item number #98 in Table 1, it is recorded that an ARP response is to be transmitted to a packet of the Ethernet protocol type=“0x0806”. The generation unit 32 outputs, to the packet processing unit 31, the packet P31 and a condition to be applied. In accordance with a notification from the generation unit 32, the packet processing unit 31 generates an ARP response (packet P34) for giving notice of a MAC address assigned to the communication device 10a. The generation unit 32 transmits the generated packet P34 to the terminal 5a via the communication unit 11 (arrow A35). By receiving the ARP response, the terminal 5a acquires the MAC address of the communication device 10a. Therefore, by using the acquired MAC address, the terminal 5a is able to perform communication.

(3) Transfer Processing of Data Packets

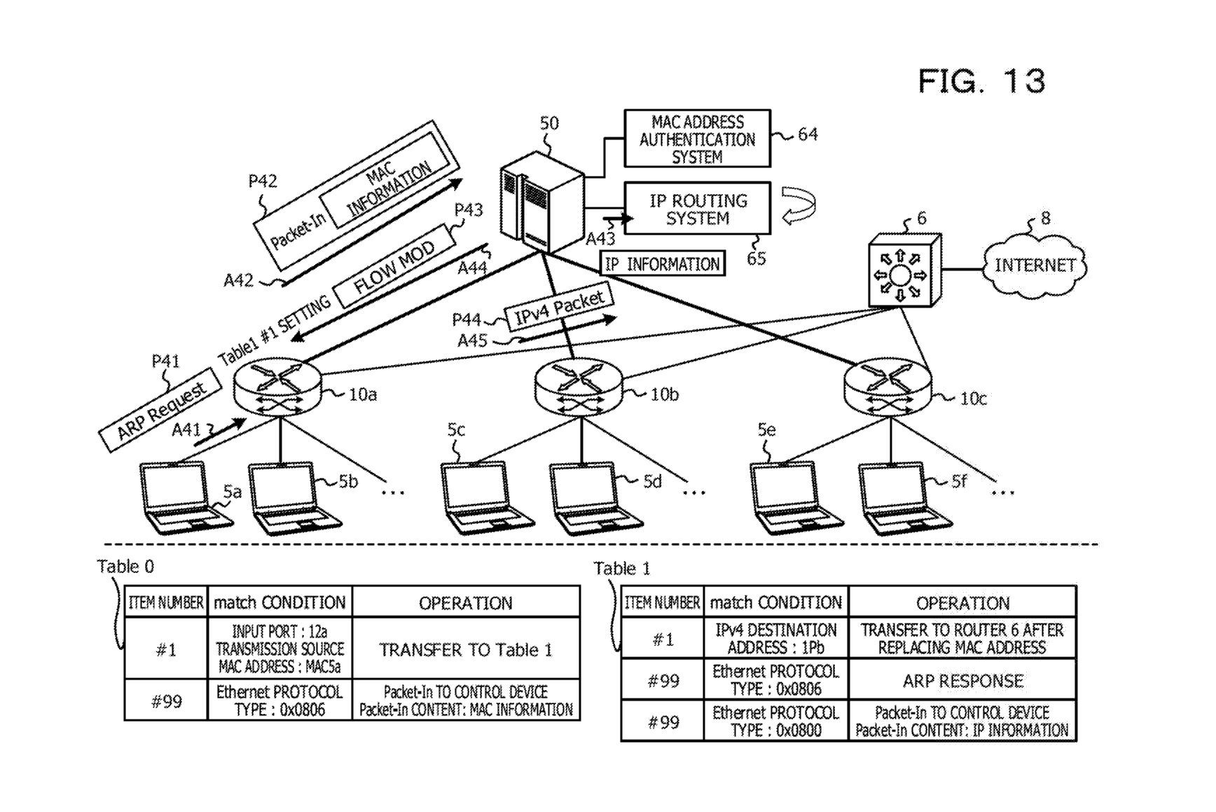

FIG. 13 is a diagram for explaining an example of transfer processing of data packets. After the authentication processing illustrated in FIG. 12 finishes, the terminal 5a generates a packet P41 in order to communicate with a device within the Internet 8. In the example of FIG. 13, the packet P41 is an IPv4 packet. Here, an IP address assigned to the terminal 5a is “IPa”. An IP address assigned to the device serving as a communication destination of the terminal 5a is “IPb”. Then, the packet P41 includes the following pieces of address information.

Ethernet Protocol Type: 0x0800

Transmission Source MAC Address: MAC5a (MAC Address of Terminal 5a)

Destination MAC Address: MAC10a (MAC Address of Communication Device 10a)

Transmission Source IP Address: IPa

Destination IP Address: IPb

Since the terminal 5a transmits the packet P41 to the communication destination, the packet P41 reaches the communication device 10a (arrow A41).

The communication unit 11 in the communication device 10a receives the packet P41 via the port 12a. The communication unit 11 outputs, to the generation unit 32, the packet P41 along with information of the input port. The generation unit 32 searches, within Table 0, for a processing rule to be applied to the packet P41. At this point of time, the communication device 10a holds the flow table 42 illustrated in FIG. 12. Therefore, the generation unit 32 determines that a combination of the transmission source MAC address and the input port of the packet P41 fits the match condition of the item number #1 in Table 0, and the generation unit 32 references Table 1. From the information of the Ethernet protocol type of the packet P41, the generation unit 32 determines that the match condition of the item number #99 in Table 1 is to be applied to the packet P41. Therefore, the generation unit 32 generates a Packet-In message (packet P42) for inquiring processing of the packet P41. While the destination IP address (IPb) of the packet P41 is included in the packet P42 as IP information, none of other pieces of information within the packet P41 are included therein. In other words, the generation unit 32 excludes, from targets to be included in the Packet-In message, information that is not specified in the entry of the item number #99 in Table 1 and that is included in the packet P41. The generation unit 32 transmits the generated Packet-In message to the control device 50 via the transmission unit 21 (arrow A42).

Upon receiving the Packet-In message of the packet P42, the reception unit 53 in the control device 50 outputs to the message processing unit 61. Since the packet P42 is the Packet-In message for inquiring a processing rule, the message processing unit 61 outputs the packet P42 to the flow control calculation unit 63. Since the packet P42 includes the IP information, the flow control calculation unit 63 determines that processing for a packet to serve as a target of path calculation processing is inquired. Therefore, the flow control calculation unit 63 determines that the IP routing system 65 is to be requested to perform path calculation processing for the destination IP address of the packet (packet P41) for which processing is inquired by the packet P42. The flow control calculation unit 63 extracts the IP information included in the packet P42 and requests the IP routing system 65 to perform the path calculation processing (arrow A43).

The IP routing system 65 preliminarily holds topology information and so forth within the communication system and is able to perform path calculation utilizing the topology information. The IP routing system 65 notifies the control device 50 of a result of the path calculation processing. In the example of FIG. 13, in the IP routing system 65, it is determined that packets addressed to “IPb” are to be transferred to the Internet 8 via the router 6. Upon obtaining a result of the path calculation, the flow control calculation unit 63 generates a processing rule. In the example of FIG. 13, in a case where the communication device 10a receives an IPv4 packet of the destination IP address=“IPb”, the flow control calculation unit 63 generates a FlowMod message (packet P43) for requesting to transfer the reception packet to the router 6. Additionally, in order to transfer the reception packet to the router 6, the packet P43 requests to set the destination MAC address of the reception packet to a MAC address set in the router 6. The flow control calculation unit 63 determines an item number to be used for registration of a condition given notice of by the packet P43 so that the condition given notice of by the packet P43 is given priority over a condition for inquiring the processing rule of the IPv4 packet of the control device 50 by using Packet-In. Here, the flow control calculation unit 63 generates the FlowMod message so that the condition of the packet P43 is registered in an item number #1 in Table 1. The flow control calculation unit 63 transmits the packet P43 to the communication device 10a via the transmission unit 52 (arrow A44).

Upon receiving the packet P43, the reception unit 22 in the communication device 10a outputs the packet P43 to the acquisition unit 33. The acquisition unit 33 registers information included in the packet P43, in the item number #1 in Table 1 within the corresponding one of the flow tables 42 included in the communication device 10a. Therefore, information of the corresponding one of the flow tables 42 held by the communication device 10a is revised from the information illustrated in FIG. 12 to such information as illustrated in FIG. 13.

Since the packet P43 is a packet that responds to the Packet-In message illustrated in the packet P42, the acquisition unit 33 notifies the generation unit 32 of a processing rule given notice of by the packet P43. The generation unit 42 outputs, to the packet processing unit 31, the packet P41 along with the processing rule given notice of. After performing revision processing of the MAC address and so forth so as to transfer the packet P41 to the router 6, the packet processing unit 31 transfers the packet P41 to the router 6 via the communication unit 11 (arrow A45).

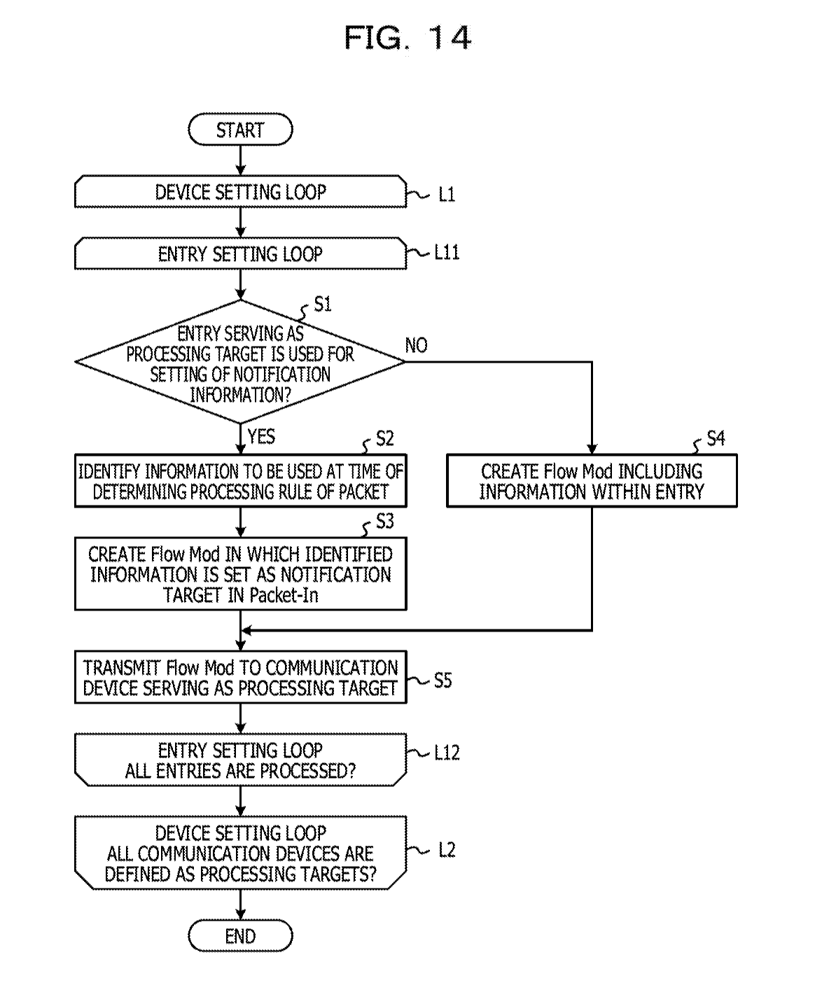

Hereinafter, with reference to flowcharts in FIG. 14 to FIG. 16, operations of respective devices will be described in chronological order.

FIG. 14 is a flowchart for explaining an example of processing in the control device 50. FIG. 14 illustrates an example of processing performed by the control device 50 at a time of notifying the communication devices 10 of information to be included in a request message. In the example of FIG. 14, a case where a Packet-In message is used as a request message and a FlowMod message including information elements illustrated in FIG. 9 or FIG. 10 is used as a notification information setting message will be described. In FIG. 14, a loop sandwiched between loop ends L1 and L2 is described as a “device setting loop”. A loop sandwiched between loop ends L11 and L12 is described as an “entry setting loop”.

First, the message processing unit 61 selects the communication device 10 to serve as a processing target, thereby starting processing in the device setting loop (the loop end L1). The message processing unit 61 selects, as an entry to serve as a processing target, an unprocessed entry within the notification information table 72, thereby starting processing in the entry setting loop (the loop end L11). The message processing unit 61 determines whether the entry serving as a processing target is an entry that holds the condition for a setting of notification information given notice of by the Packet-In message (S1). In a case where the entry serving as a processing target is an entry that holds a condition for a setting of notification information, the message processing unit 61 identifies, from the entry serving as a processing target, information to be used at a time of determining a processing rule of a packet (Yes in S1, S2). The message processing unit 61 generates a FlowMod message in which the identified information is set as a notification target In the Packet-In message (S3). After that, the message processing unit 61 transmits the generated FlowMod to the communication device 10 serving as a processing target, via the transmission unit 52 (S5).

On the other hand, in a case where the entry serving as a processing target is not an entry that holds the condition for a setting of notification information, the message processing unit 61 generates a FlowMod message including information within the entry (No in S1, S4). The FlowMod message generated in S4 does not have to have a format that references FIG. 9 or FIG. 10. In a case where the processing operation in S4 is performed, the processing operation in S5 is performed.

The message processing unit 61 determines whether all entries within the notification information table 72 are processed (the loop end L12). In a case where all the entries within the notification information table 72 are not processed, processing operations subsequent to the loop end L11 are repeated. On the other hand, in a case where all the entries within the notification information table 72 are processed, the message processing unit 61 determines whether all the communication devices 10 within the network are defined as processing targets (the loop end L2). At this time, the message processing unit 61 is able to arbitrarily use the topology information within the network. In a case where all the communication devices 10 within the network are not defined as processing targets, the message processing unit 61 repeats the processing operations subsequent to the loop end L11 after changing the communication device 10 serving as a processing target. On the other hand, in a case where all the communication devices 10 within the network are defined as processing targets, the message processing unit 61 terminates the processing.

FIG. 14 is just an example and may be arbitrarily changed in response to an implementation. The device setting loop may be included in, for example, the entry setting loop. In this case, after setting processing for a specific entry is performed for all the communication devices 10 within the network, processing for information of another entry is performed.

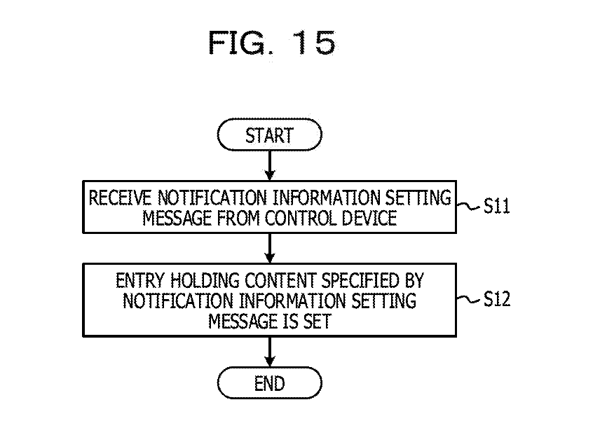

FIG. 15 is a flowchart for explaining an example of processing in the communication device 10 that receives the notification information setting message. The reception unit 22 in the corresponding one of the communication devices 10 receives the notification information setting message from the control device 50 (S11). The reception unit 22 outputs the notification information setting message to the acquisition unit 33. Then, the acquisition unit 33 sets, within the flow table 42, an entry holding a content specified by the notification information setting message (S12).

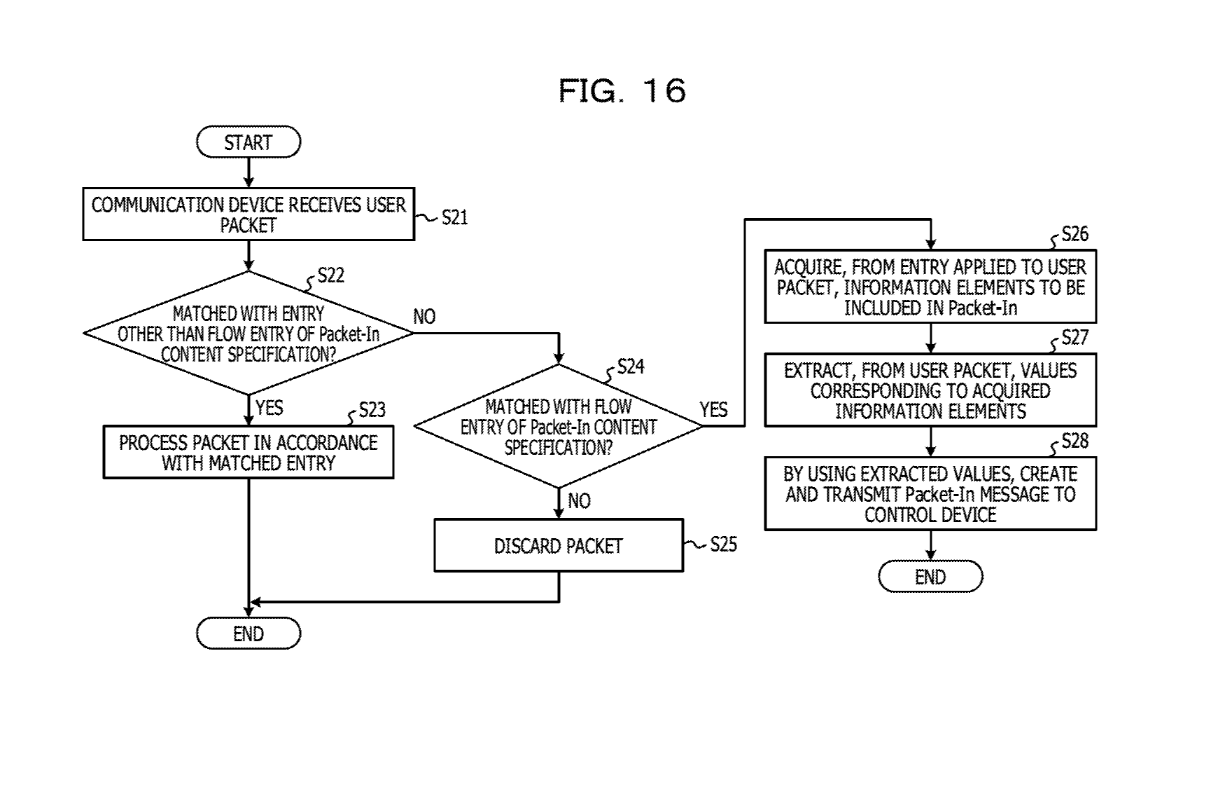

FIG. 16 is a flowchart for explaining an example of processing in the corresponding one of the communication devices 10 at a time of requesting a processing rule. In FIG. 16, the Packet-In message is used as a request message. In FIG. 16, in order to easily discriminate from other entries, the entry holding a content specified by the notification information setting message is described as a “flow entry of Packet-In content specification”.

The communication unit 11 in the corresponding one of the communication devices 10 receives a user packet (S21). The generation unit 32 determines whether the user packet is matched with a match condition of an entry other than the flow entry of Packet-In content specification (S22). In a case where the user packet is matched with a match condition of an entry other than the flow entry of Packet-In content specification, the packet processing unit 31 processes the packet in accordance with the matched entry (Yes in S22, S23). On the other hand, in a case of being determined, in S22, as not matched, the generation unit 32 determines whether the user packet is matched with a match condition of the flow entry of Packet-In content specification (S24). In a case where the user packet is not matched with the match condition of the flow entry of Packet-In content specification, the generation unit 32 discards the user packet (No in S24, S25).

In a case where the user packet is matched with the match condition of the flow entry of Packet-In content specification, the generation unit 32 determines that the entry serving as a processing target is to be applied to the user packet (Yes in S24). The generation unit 32 acquires, from the entry applied to the user packet, information elements to be included in the Packet-In message (S26). The generation unit 32 extracts, from the user packet, values corresponding to the acquired information elements (S27). Furthermore, by using the extracted values, the generation unit 32 creates and transmits the Packet-In message to the control device 50 (S28).

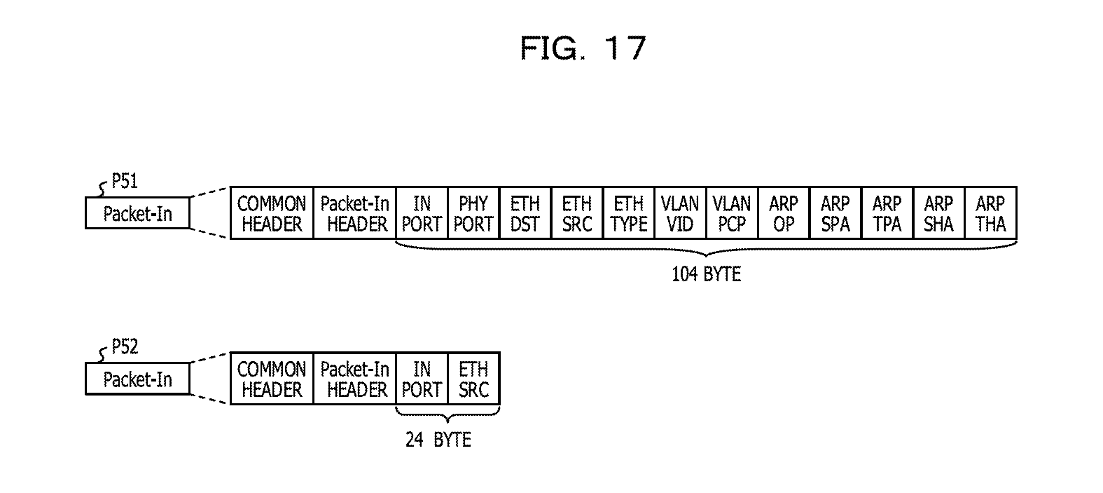

FIG. 17 is a diagram for explaining an example of reduction of information transmitted and received between the control device 50 and the corresponding one of the communication devices 10. A packet P51 is an example of the Packet-In message transmitted and received in a case where the communication method according to an embodiment is not applied. In the packet P51, a processing rule for an ARP packet is inquired. In addition to a common header and a Packet-In header, the Packet-In message at this time further includes pieces of information such as a virtual local area network (VLAN) ID and a VLAN priority (VLAN PCP). In a case of the packet P51, an input port (IN PORT), a physical port (PHY PORT), a destination MAC address (ETH DST), a transmission source MAC address (ETH SRC), and an ether type (ETH TYPE) are further included. An ARP opcode (ARP OP), an ARP transmission source IP address (ARP SPA), and an ARP target IP address (ARP TPA) are further included in the packet P51. Furthermore, an ARP transmission source MAC address (ARP SHA), an ARP target MAC address (ARP THA), and so forth are further included in the packet P51. Therefore, in an example of the packet P51, information of 104 bytes is included subsequent to the common header and the Packet-In header.

On the other hand, the Packet-In message used by the corresponding one of the communication devices 10 according to an embodiment to inquire a processing rule for an ARP packet is illustrated by a packet P52. The packet illustrated by the packet P52 only includes the input port and the transmission source MAC address in addition to the common header and the Packet-In header. Therefore, in the example of the packet P52, information of 24 bytes only has to be included subsequent to the common header and the Packet-In header.

The total amount of the common header and the Packet-In header is about 80 bytes. Therefore, in the packet P51, 80+104=184 bytes are transmitted as 1 Packet-In message. However, based on the method according to an embodiment, 1 Packet-In message only has to have 80+24=104 bytes, as illustrated in the packet P52. Therefore, by using the method according to an embodiment, it is possible to suppress an information amount transmitted by the Packet-In message to a level of about 104/184=56% of a case of not using the method according to an embodiment. Accordingly, in the method according to an embodiment, it is possible to reduce an information amount to about half of a case of not using the method according to an embodiment, the information amount being transmitted and received between the control device 50 and the corresponding one of the communication devices 10 in a case of a target of an inquiry about a processing rule. Accordingly, it is possible to reduce a data communication amount between the corresponding one of the communication devices 10 and the control device 50.

An example of data reduction described with reference to FIG. 17 is just an example. Depending on the number of information elements included in the Packet-In message used in the communication method according to an embodiment, a reduction state of data transmitted and received between the corresponding one of the communication devices 10 and the control device 50 may vary. However, by using the communication method according to an embodiment, data not to be used in processing in the control device 50, the application server, or the like is inhibited from being transmitted to the control device 50 by the corresponding one of the communication devices 10. From this, communication between the control device 50 and the corresponding one of the communication devices 10 is made efficient.

An embodiment is not limited to the above and may be variously modified. Hereinafter, some examples thereof will be described.

While, in the above description, in order to indicate that information of which the control device 50 is notified varies depending on an application used for determination of a processing rule, a case where packets are processed by applications is described as an example, this is just an example. Even in, for example, a case where a processing rule is generated by 1 type of application in the control device 50, the control device 50 notifies the communication devices 10 of information to be used for determination of a processing rule, as a target to be included in a request message. Furthermore, explanations described with reference to FIG. 11 to FIG. 13 and so forth are just examples. The type of application used for determination of a processing rule is arbitrary. An application used for determination of a processing rule may operate in the flow control calculation unit 63 in the control device 50.

In the example of FIG. 13, for simplicity's sake, a case where the communication devices 10 are coupled to the Internet 8 via the router 6 is described. However, the communication devices 10 may be coupled to the Internet 8 via a core switch compatible with a Layer 2. In a case where the communication devices 10 are coupled to the Internet 8 via the core switch compatible with the Layer 2, the communication devices 10 each transfer a packet addressed to the Internet 8 after switching a MAC address of an L3 switch or a router within the Internet 8 to a destination MAC address.

A format of each of tables and messages illustrated in the above description is just an example, and information elements included in each of the tables and the messages may be arbitrarily modified in response to an implementation.

While, in the above description, a case where the control device 50 holds the notification information table 72 is adopted as an example, this is just an example. By using an arbitrary method, the control device 50 may acquire a combination of information elements requested to be included in a request message and characteristic information of a packet. For the control device 50, each individual application system such as the IP routing system 65 or the MAC address authentication system 64 may notify the control device 50 of information to be used for processing, for example. In this case, the message processing unit 61 in the control device 50 combines pieces of characteristic information of packets processed in individual systems and information elements given notice of by the individual systems, thereby acquiring pieces of information of which the communication devices 10 are to be notified.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a processor included in a communication device to process a packet based on a processing rule determined by a control device, the communication method comprising:
acquiring, from the control device, a setting message including a combination of an information element of which the control device is notified at a time of inquiring the processing rule and characteristic information indicating a characteristic of a packet serving as a target for which the processing rule is inquired;
receiving a packet serving a processing target;
generating a request message that is used for requesting the processing rule and that includes a value of the information element, which corresponds to the received packet, when the received packet satisfies the characteristic information included in the setting message; and
transmitting the request message to the control device.

2. The communication method according to claim 1,
wherein the generating includes excluding, from targets to be included in the request message, information that is included in pieces of information included in the received packet and that is not associated with the characteristic information.

3. The communication method according to claim 1, further comprising:
determining whether the received packet satisfies the characteristic information included in flow information in which characteristic information indicating a characteristic of a packet and a processing rule of the packet are associated with each other, by referencing, for each of characteristics of a packet, the flow information;
processing the received packet in accordance with a processing rule that corresponds to the characteristic information and that is included in the flow information, when it is determined that the received packet satisfies the characteristic information; and
determining whether the received packet satisfies the characteristic information included in the setting message, when it is determined that the received packet does not satisfy the characteristic information.

4. The communication method according to claim 3, wherein
the flow information includes a first degree of priority that indicates a priority order of an application of the processing rule and that is assigned to each of the characteristics, and
the determining whether the received packet satisfies the characteristic information included in the flow information includes determining, in accordance with an order based on the first degree of priority, whether the received packet satisfies the characteristic information included in the flow information.

5. The communication method according to claim 4, wherein
the setting message includes a second degree of priority indicating a priority order of an application of the processing rule, and
the second degree of priority is lower than the first degree of priority.

6. The communication method according to claim 5, further comprising:
updating, based on information stored in the setting message, the flow information, at a time of acquiring the setting message,
wherein the determining whether the received packet satisfies the characteristic information included in the flow information includes determining, in accordance with an order based on the first degree of priority and the second degree of priority, whether the received packet satisfies the characteristic information included in the flow information.

7. The communication method according to claim 3, further comprising:
discarding the received packet in a case where it is determined that the received packet does not satisfy the characteristic information included in the setting message.

8. The communication method according to claim 1, further comprising:
extracting the value from the received packet.

9. The communication method according to claim 1, wherein the acquiring includes acquiring a first combination in which first characteristic information indicating a characteristic of a packet to be processed by a first application and a first information element are associated with each other and a second combination in which second characteristic information indicating a characteristic of a packet to be processed by a second application and a second information element are associated with each other, and
the generating includes:
generating a request message including the first characteristic information in a case where the packet serving as a processing target satisfies the first information element, and
generating a request message including the second information element in a case where the packet serving as a processing target satisfies the second characteristic information.

10. A communication device to process a packet based on a processing rule determined by a control device, the communication device comprising:
a memory; and
a processor coupled to the memory and configured to:
acquire, from the control device, a setting message including a combination of an information element of which the control device is notified at a time of inquiring the processing rule and characteristic information indicating a characteristic of a packet serving as a target for which the processing rule is inquired,
receive a packet serving a processing target,
generate a request message that is used for requesting the processing rule and that includes a value of the information element, which corresponds to the received packet, when the received packet satisfies the characteristic included in the setting message, and
transmit the request message to the control device.

11. The communication device according to claim 10,
wherein the processor is configured to exclude, from targets to be included in the request message, information that is included in pieces of information included in the received packet and that is not associated with the characteristic information.

12. The communication device according to claim 10, wherein the processor is configured to:
determine whether the received packet satisfies the characteristic information included in flow information in which characteristic information indicating a characteristic of a packet and a processing rule of the packet are associated with each other, by referencing, for each of characteristics of a packet, the flow information,
process the received packet in accordance with a processing rule that corresponds to the characteristic information and that is included in the flow information, when it is determined that the received packet satisfies the characteristic information, and
determine whether the received packet satisfies the characteristic information included in the setting message, when it is determined that the received packet does not satisfy the characteristic information.

13. The communication device according to claim 12, wherein
the flow information includes a first degree of priority that indicates a priority order of an application of the processing rule and that is assigned to each of the characteristics, and
the processor is configured to determine, in accordance with an order based on the first degree of priority, whether the received packet satisfies the characteristic information included in the flow information.

14. The communication device according to claim 13, wherein
the setting message includes a second degree of priority indicating a priority order of an application of the processing rule, and
the second degree of priority is lower than the first degree of priority.
